(19) United States
(12) Patent Application Publication
(10) Pub. No.: US 2010/0088149 A1
(43) Pub. Date: Apr. 8, 2010

(54) METHODS, SYSTEMS, AND COMPUTER PROGRAM PRODUCTS FOR PRESENTING TRANSACTION-SPECIFIC MARKETING AT THE POINT-OF-SALE AND RELATED DEVICES

(75) Inventors: Marc Sullivan, Austin, TX (US); Phil Kortum, Houston, TX (US); James Pratt, Round Rock, TX (US)

Correspondence Address: AT&T Legal Department - MB;Attn: Patent Docketing, Room 2A-207, One AT&T Way, Bedminster, NJ, 07921, US

(73) Assignee: AT&T Intellectual Property I, L.P.

(21) Appl. No.: 12/246,939

(22) Filed: Oct. 7, 2008

(51) Int. Cl. G06Q 30/00; G06Q 40/00

(52) U.S. Cl. 705/10; 705/16; 705/21; 705/14.39

(57) ABSTRACT

A notification of a transaction is received via a device associated with a point-of-sale. A transaction-specific offer from a credit source is presented to a user at the point-of-sale responsive to receiving the notification. The transaction may be completed using the credit source associated with the transaction-specific offer responsive to presenting the transaction-specific offer.

### BACKGROUND

The present invention relates to secure transactions, and, more particularly, to methods, systems, and computer program products for conducting secure transactions using wireless network technologies.

The average consumer in the United States may have about 9 credit cards. In 2008, the Credit And Charge Card Market is projected to reach a value of nearly $4.2 billion. Credit card companies (CCCs) may spend significant amounts of marketing money in attempts to influence cardholders to use the CCC's credit card instead of a competitor's credit card.

Contactless payment is a relatively new payment technology that may add speed and convenience to credit transactions. Contactless payment relies on radio frequency (RF) identification and near field communication (NFC) technology to carry account information from a chip embedded in a portable device (e.g., a credit card, keychain fob, cell phone, wristwatch, etc.) to merchant's point-of-sale (POS) terminal. NFC is a short-range, wireless connectivity technology standard that is designed to enable simple and secure communication between electronic devices. NFC technology operates by using magnetic field induction and allows connectivity to be achieved between two devices by simply bringing the two devices within a small distance, e.g., a few centimeters, of one another. For example, if a mobile terminal, such as a cellular phone, is equipped with NFC technology and includes credit card information for one or more credit card accounts, a credit or debit transaction can be completed within seconds by merely placing the phone in proximity to an NFC-enabled point-of-sale terminal.

### SUMMARY

According to some embodiments, a method of operating an electronic device to conduct a transaction includes receiving a notification of the transaction at the electronic device. A transaction-specific offer from a credit source is presented to a consumer via the electronic device at a point-of-sale responsive to receiving the notification at the electronic device.

In some embodiments, details of the transaction may be transmitted, either directly or indirectly, to the credit source responsive to receiving the notification at the electronic device. The transaction-specific offer may be received at the electronic device, either directly or indirectly, from the credit source responsive to transmitting the details of the transaction thereto.

In other embodiments, the details of the transaction may be transmitted to a plurality of available credit sources for the consumer responsive to receiving the notification, and a plurality of transaction-specific offers may be received from at least some of the plurality of available credit sources responsive to transmitting the details of the transaction thereto. The plurality of transaction-specific offers may be presented to the consumer responsive to receipt thereof.

In some embodiments, competing ones of the plurality of transaction-specific offers may be transmitted to one of the plurality of available credit sources, and a revised transaction-specific offer may be received from the one of the plurality of available credit sources responsive to transmitting the competing ones of the plurality of transaction-specific offers thereto. The revised transaction-specific offer may be presented to the consumer along with the competing ones of the plurality of transaction-specific offers.

In other embodiments, the electronic device may be a credit aggregator device configured to communicate with the plurality of available credit sources, and the notification of the transaction may be received from a mobile terminal associated with the consumer. The transaction-specific offer may be presented by transmitting the plurality of transaction-specific offers to the mobile terminal responsive to receiving the plurality of transaction-specific offers from the respective ones of the plurality of available credit sources.

In some embodiments, the electronic device may be a mobile terminal including account information for the plurality of available credit sources, and the notification of the transaction may be received from a point-of sale terminal. The plurality of transaction specific-offers may be presented by displaying the plurality of transaction-specific offers on a display of the mobile terminal. A consumer selection of one of the plurality of available credit sources may be received responsive to displaying the plurality of transaction-specific offers, and the transaction may be completed by transmitting account information associated with the one of the plurality of available credit sources to the point-of sale terminal responsive to receiving the consumer selection thereof.

In other embodiments, the electronic device may be a credit server associated with the credit source, and the notification of the transaction may be received from one of a mobile terminal associated with the consumer and a credit aggregator device configured to communicate with the mobile terminal. The transaction-specific offer may be presented by transmitting the transaction-specific offer to the one of the mobile terminal and the credit aggregator device responsive to receiving the notification of the transaction therefrom. The transaction may be completed with a point-of-sale terminal responsive to receiving account information for the consumer from the point-of-sale terminal.

In some embodiments, at least one competing offer for the transaction associated with another credit source may be received. A revised transaction-specific offer may be presented to the consumer in response to receiving the at least one competing offer.

In other embodiments, the notification may indicate at least one of a purchase amount, a vendor associated with the transaction, and an identification of items to be purchased in the transaction.

In some embodiments, the transaction-specific offer may be an offer for at least one of an annual percentage rate, a reward, and a contractual term as consideration for completion of the transaction using the credit source.

In other embodiments, the credit source may be a server associated with a credit card company, a bank, and/or other financial institution with whom the consumer has an active account.

According to other embodiments, an electronic device for conducting a transaction includes a receiver and a processor coupled to the receiver. The receiver is configured to receive a notification of the transaction. The processor is configured to present a transaction-specific offer from a credit source to a consumer at a point-of-sale responsive to receipt of the notification.

In some embodiments, the electronic device may further include a transmitter coupled to the processor. The transmitter may be configured to transmit transaction details of the transaction either directly or indirectly to the credit source responsive to receipt of the notification. The receiver may be configured to receive the transaction-specific offer either directly or indirectly from the credit source responsive to transmission of the details of the transaction thereto.

In other embodiments, the transmitter may be further configured to transmit the details of the transaction to a plurality of available credit sources for the consumer. The receiver may be further configured to receive a plurality of transaction-specific offers from at least some of the plurality of available credit sources responsive to transmission of the details of the transaction thereto. The processor may be further configured to present the plurality of transaction-specific offers to the consumer responsive to receipt thereof.

In some embodiments, the transmitter may be configured to transmit competing ones of the plurality of transaction-specific offers to one of the plurality of available credit sources. The receiver may be configured to receive a revised transaction-specific offer from the one of the plurality of available credit sources responsive to transmitting the competing ones of the plurality of transaction-specific offers thereto. The processor may be configured to present the revised transaction-specific offer to the consumer along with the competing ones of the plurality of transaction-specific offers.

In other embodiments, the electronic device may be a credit aggregator device configured to communicate with the plurality of available credit sources. The receiver may be configured to receive the notification of the transaction from a mobile terminal associated with the consumer. The processor may be configured to present the plurality of transaction-specific offers by transmitting the plurality of transaction-specific offers to the mobile terminal via the transmitter responsive to receipt of the plurality of transaction-specific offers from the respective ones of the plurality of available credit sources.

In some embodiments, the electronic device may be a mobile terminal including account information for the plurality of available credit sources. The receiver may be configured to receive the notification of the transaction from a point-of-sale terminal. The electronic device may further include a display coupled to the processor and configured to present the plurality of transaction-specific offers by displaying the transaction-specific offers thereon, and a user interface configured to receive a consumer selection of one of the plurality of available credit sources responsive to display of the plurality of transaction-specific offers via the display. The processor may be configured to complete the transaction by transmitting account information associated with the one of the plurality of available credit sources to the point-of sale terminal via the transmitter responsive to receipt of the consumer selection thereof via the user interface.

In other embodiments, the electronic device may be a credit server associated with the credit source. The receiver may be configured to receive the notification of the transaction from one of a mobile terminal associated with the consumer and a credit aggregator device configured to communicate with the mobile terminal. The electronic device may further include a transmitter coupled to the processor and configured to present the transaction-specific offer by transmitting the transaction-specific offer to the one of the mobile terminal and the credit aggregator device responsive to receipt of the notification of the transaction therefrom. The processor may be configured to complete the transaction with a point-of-sale terminal responsive to receiving account information for the consumer therefrom via the receiver.

In some embodiments, the receiver may be further configured to receive at least one competing offer for the transaction associated with another credit source, and the processor may be configured to present a revised transaction-specific offer to the consumer responsive to receipt of the at least one competing offer.

Other methods, systems, devices, and/or computer program products according to other embodiments will become apparent to one with skill in the art upon review of the following drawings and detailed description. It is intended that all such additional methods, systems, devices, and/or computer program products be included within this description, be within the scope of the present invention, and be protected by the accompanying claims.

### BRIEF DESCRIPTION OF THE DRAWINGS

FIG. 1 is a block diagram illustrating a system for providing transaction-specific offers from a plurality of credit sources to an electronic device at a point-of-sale in accordance with some embodiments;

FIG. 2 is a block diagram that illustrates a hardware/software architecture for a mobile terminal in accordance with some embodiments;

FIG. 3 is a block diagram that illustrates a hardware/software architecture of a credit aggregator device in accordance with some embodiments;

FIG. 4 is a block diagram that illustrates a hardware/software architecture of a credit source server in accordance with some embodiments;

FIG. 5 is a flowchart that illustrates operations for providing transaction-specific offers at the point-of-sale in accordance with some embodiments; and

FIG. 6 is a flow diagram that illustrates operations for providing transaction-specific offers from a plurality of credit sources to an electronic device at a point-of-sale in accordance with some embodiments.

### DETAILED DESCRIPTION

Specific exemplary embodiments will now be described with reference to the accompanying drawings. The embodiments described herein should not be construed as limiting. The terminology used in the detailed description of the particular exemplary embodiments illustrated in the accompanying drawings is not intended to be limiting. In the drawings, like numbers refer to like elements.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first electronic device could be termed a second electronic device, and, similarly, a second electronic device could be termed a first electronic device without departing from the teachings of the disclosure.

As used herein, the term “mobile terminal” may include any wired and/or wireless portable device that is capable of communicating credit account information to a point-of-sale (POS) terminal, and may include a satellite or cellular radiotelephone with or without a multi-line display; a Personal Communications System (PCS) terminal that may combine a cellular radiotelephone with data processing, facsimile and/or data communications capabilities; a PDA that can include a radiotelephone, pager, Internet/intranet access, Web browser, organizer, calendar and/or a global positioning system (GPS) receiver; and/or a notebook or palmtop computer that includes a wireless local area network transceiver.

For purposes of illustration, embodiments are described herein in the context of a mobile terminal. It will be understood, however, that the present invention is not limited to such embodiments and may be embodied generally as any electronic device, fixed or mobile, that is configured to communicate with a point-of-sale terminal to perform a transaction.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the present application and the relevant art, and will not be interpreted in an idealized or overly formal sense unless expressly so defined herein.

Some embodiments may arise from realization that present marketing efforts by credit card companies (CCCs),: for example, via telephone, mail, and/or e-mail solicitations, may lack full effectiveness in that they are not presented to the consumer at the critical time interval, that is, when a purchase is about to occur and the consumer is deciding which credit card to use. Marketing messages may be extremely effective when provided at the time a consumer is making a purchase decision. In particular, the closer to the decision point, the more effective the marketing message may be in influencing the purchase. However, CCCs currently have limited capabilities to market their product to the consumer at the critical time when the consumer is choosing which credit source to use.

Accordingly, some embodiments provide methods, systems, and computer program products for connecting a consumer's portable electronic device, such as a mobile terminal, to credit sources/financial service providers at the time of purchase, and presenting transaction-specific offer information from the credit sources from which the consumer can choose to complete the transaction at the point-of-sale. The transaction-specific offer information may include any type of reward or incentive (e.g., interest rate, cash-back, points, airline miles, etc.) offered to the consumer in exchange for using the credit source as the source of payment for that particular transaction. As used herein, the “point-of-sale” may refer to the location at which payment for goods and/or services is made. For example, in an establishment that sells goods and/or services, the point-of-sale may be a cash register and/or a checkout counter in the establishment. In contrast, for an internet purchase with an on-line vendor, the point-of-sale may be the consumer's computer and/or other terminal used to transmit payment information to the on-line vendor.

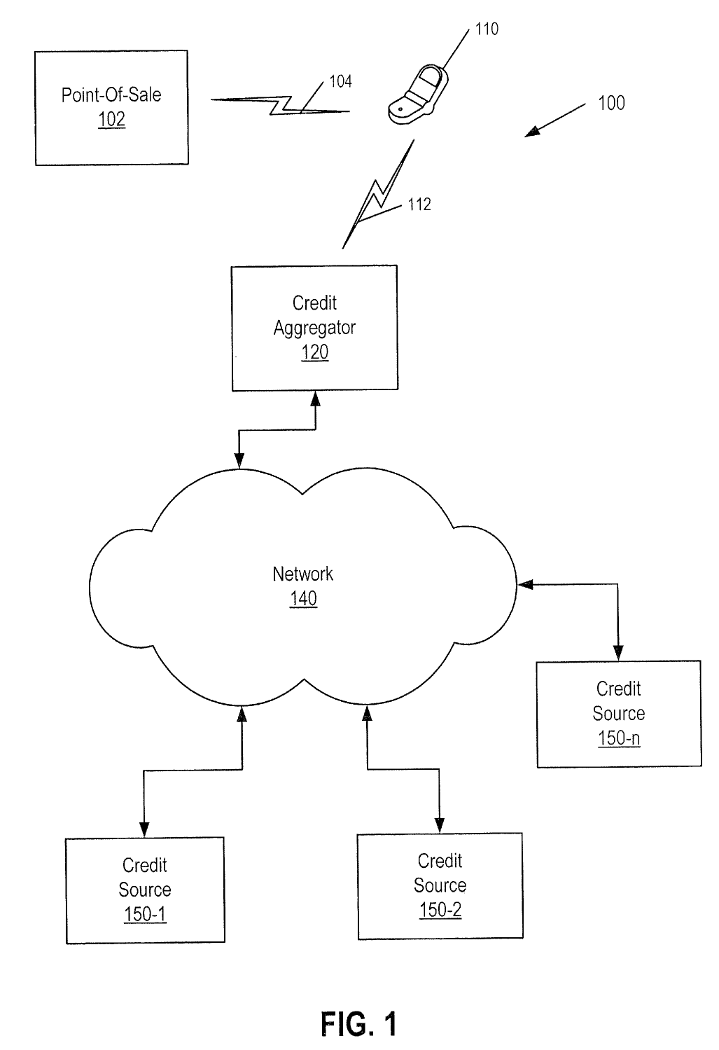

FIG. 1 illustrates a system for providing transaction-specific offers from a plurality of credit sources to an electronic device at a point-of-sale in accordance with some embodiments. As shown in FIG. 1, the system 100 includes a point of sale (POS) terminal 102, a mobile terminal 110, and a credit aggregator device 120. The credit aggregator device 120 is connected to one or more credit sources 150-1 through 150-n via network 140. The network 140 may be a private network, a public network, or a combination thereof, and may be implemented as an Internet Protocol (IP) based network or in compliance with another network protocol. The credit sources 150-1 through 150-n may be servers associated with credit card companies, banking facilities, and/or other financial institutions with whom the subscriber of the mobile terminal 110 has an active account. It should be appreciated that there may be other authorized users of the mobile terminal 110, in addition to the subscriber. For example, the credit source 150-1 may be a credit card company, such as American Express®, the credit source 150-2 may be an electronic funding company, such as PayPal®, and the credit source 150-n may be a bank, such as BB&T.

The system 100 presents a user of the mobile terminal 110 with transaction-specific offers from one or more of the credit sources 150-1 through 150-n at the point-of-sale. For example, transaction-specific offers may include an offer for a favorable interest rate applicable to the transaction, a points-based and/or other incentive or reward, and/or a change in contractual terms (e.g., lower APR, lower yearly fees, etc.) in exchange for completion of the transaction using the credit source associated with the offer. The system 100 may present the transaction-specific offers to the user of mobile terminal 110 in real-time, at the time of the transaction. The user of the mobile terminal 110 may thereby choose to complete the transaction using a particular one of the available credit accounts or sources of credit 150-1 through 150-n based on the most attractive offer to the user. Although the system 100 is described herein with respect to consumer, point-of-sale transactions, it will be understood that the described system 100 may also be used in non-consumer applications and/or environments, such as industrial, governmental, and/or educational environments.

More particularly, the POS terminal 102 communicates messages 104 associated with a financial transaction to the mobile terminal 110. As shown in FIG. 1, messages 104 associated with the transaction are wirelessly transmitted by POS terminal 102 and received by mobile terminal 110. The messages 104 may, in some embodiments, be formatted to comply with a localized wireless connection protocol, such as a Bluetooth, Wi-Fi, and/or IR connection protocol. However, for security purposes, wireless connection options with a more limited range may be used. For example, the POS terminal 102 and the mobile terminal 110 may respectively include a near-field communication (NFC) module configured for communication according to the ISO 14443 (RFID) contactless smart card standard, for instance, using MIFARE technology. Thus, the messages 104 may be communicated between the POS terminal 102 and the mobile terminal 110 via magnetic field induction over the 13.56 MHz frequency band within a range of about 10 cm in some embodiments.

The message(s) 104 transmitted to the mobile terminal 110 may include a notification of the currently-pending transaction, and may further include transaction details about the items that are being purchased by the user of mobile terminal 110. For example, the message(s) 104 may include an identification of the items to be purchased in the transaction, either in the form of a text-based identification or a numeric or alphanumeric product code, bar code, or the like associated with each item. The messages 104 may also include the price per item, total purchase amount, and/or vendor/seller identification information. The messages 104 may be transmitted from the POS terminal 102 to the mobile terminal 110 in response to an indication from an operator of the POS terminal 102 that the consumer/user of the mobile terminal 110 is ready to checkout, e.g., that all items to be purchased have been scanned or otherwise input to the POS terminal 102.

The mobile terminal 110 as described herein is operable to receive messages 104 transmitted from POS device 102 and to initiate a process to receive transaction-specific offers from one or more of the credit sources 150-1 through 150-n. In FIG. 1, for example, mobile terminal 110 is shown in wireless communication 112 with a credit aggregator device 120. The communication between the mobile terminal 110 and credit aggregator device 120 may be provided via a cellular transmission protocol that is supported by the mobile terminal 110 in some embodiments. For example, the communication 112 between the mobile terminal 110 and the credit aggregator device 120 may comply with a second generation (2G) or third generation (3G) cellular transmission protocol. Although illustrated in FIG. 1 as a separate entity configured to wirelessly communicate with the mobile terminal 110, it is to be understood that the credit aggregator device 120 may be included as a module within the mobile terminal 110 in some embodiments.

As shown in FIG. 1, the mobile terminal 110 receives a notification and/or other message 104 from POS device 102 indicating that all items being purchased have been scanned or otherwise recognized by the POS device 102. When the message 104 is received by the mobile terminal 110, the mobile terminal 110 communicates details of the pending transaction to the credit aggregator device 120. The transaction details may include an indication of the consumer's identity, as well as a total purchase price, an identification of the items being purchased, and/or an indication of the vendor's identity.

The credit aggregator device 120 is configured to communicate via the network 140 with one or more of the available credit sources 150-1 through 150-n with whom the user of the mobile terminal 110 has an active account. In particular, after receiving the transaction details from the mobile terminal 110, the credit aggregator device 120 may communicate the transaction details to all of the available credit sources 150-1 through 150-n. In response, one or more of the credit sources 150-1 through 150-n may transmit a real-time transaction-specific offer (e.g., a purchase-specific interest rate, purchase-specific cash-back/rewards, more favorable contractual terms, etc.) to the credit aggregator device 120 to entice the user of the mobile terminal 110 to complete the transaction using that credit source. As the transaction details may include the purchased items and/or vendor information, the transaction-specific offers from one or more of the credit sources 150-1 through 150-n may be specific to the vendor and/or the particular items purchased. For example, the credit source 150-1 may have an arrangement with particular vendors and/or manufacturers to offer more favorable credit terms to promote sales of particular items made by the manufacturer and/or sold by the vendor. Upon receiving multiple offers from the credit sources 150-1 through 150-n, the credit aggregator 120 may forward the details of competing offers from the other credit sources back to each of the offering credit sources 150-1 through 150-n. As such, in light of the competing offers, one or more of the credit sources 150-1 through 150-n may revise its current offer and transmit a new or revised transaction-specific offer to the credit aggregator 120.

When the credit aggregator device 120 has received all of the transaction-specific offers and/or after a predetermined time of transmitting the transaction details to the credit sources 150-1 through 150-n, the credit aggregator device 120 consolidates and forwards the received offers to the mobile terminal 110. The mobile terminal 110 may include computer software modules that are configured to present the transaction-specific offers to the user of the mobile terminal 110 in a graphical user interface (GUI) that displays the available sources of credit 150-1 through 150-n and the transaction-specific offers associated with one or more of the indicated credit sources 150-1 through 150-n. The mobile terminal 110 then monitors for a keypad or other user input indicating the user's selection of one of the available credit sources. When the user selects one of the available credit sources 150-1 through 150-n displayed in the GUI, the mobile terminal 110 transmits a message 104 to the POS device 102 indicating the selected credit source and/or account information associated with the selected credit source. For example, based on the transaction-specific offer therefrom, the user may select credit source 150-1 to complete the transaction. The POS device 102 may then validate the user of the mobile terminal 110 (for example, based on a signature or personal identification number (PIN)) and initiate a credit processing transaction with the selected credit source 150-1 responsive to the validation. Thus, the system 100 is operable to permit the credit sources 150-1 through 150-n to present offers to consumers at the point-of sale, when the offers may exert the most influence on purchase decisions.

Although FIG. 1 illustrates an exemplary system 100 for presenting transaction-specific offers from a plurality of credit sources at the point-of-sale, it will be understood that the present invention is not limited to such configurations, but is intended to encompass any configuration capable of carrying out the operations described herein. For example, although described in FIG. 1 with reference to a standalone credit aggregator device 120, it is to be understood that some or all of the functionality of the credit aggregator device 120 may be implemented in the mobile terminal 110 in some embodiments. Thus, in such embodiments, the mobile terminal 110 including the credit aggregator device 120 may communicate transaction details directly to one or more of the credit sources 150-1 to 150-n, for example, using a wireless TCP/IP connection. Also, although described with reference to transmission of wireless messages 104 between the mobile terminal 110 and the POS terminal 102, it is to be understood that the messages 104 may be transmitted via a wired connection between the mobile terminal 110 and the POS terminal 102 and/or via the network 140 in some embodiments, for instance, where the mobile terminal 110 is a laptop computer. Moreover, in some embodiments, a desktop computer or other non-portable consumer electronic device may be used to access the POS terminal 102 over a wired connection via a network, such as the Internet, in a manner similar to that described above with reference to the mobile terminal 110.

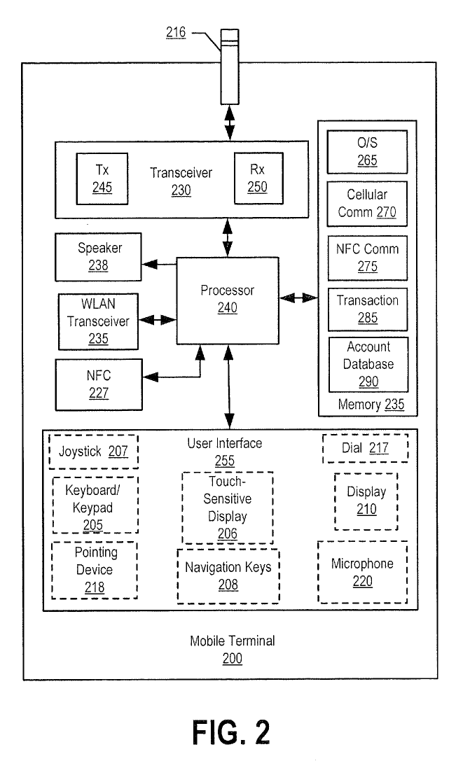

FIG. 2 illustrates an electronic device/mobile terminal 200 in accordance with some embodiments. In some embodiments, the mobile terminal 200 may correspond to the mobile terminal 110 of FIG. 1. Referring now to FIG. 2, the mobile terminal 200 includes a transceiver 230, an antenna 216, a processor 240, a memory 235, a speaker 238 and a user interface 255. Depending on the functionalities offered by the wireless device 200, the user interface 255 may include a microphone 220, a display 210 (such as a liquid crystal display), a joystick 207, a keypad 205, a touch sensitive display 206, a dial 217, navigation/directional keys 208, and/or a pointing device 218 (such as a mouse, track ball, touch pad, etc.). However, additional and/or fewer elements of the user interface 255 may actually be provided. For example, the touch sensitive display 206 may be provided in a personal digital assistant (PDA) that does not include a display 210, a keypad 205, and/or a pointing device 218.

The transceiver 230 includes a transmitter circuit 245 and a receiver circuit 250, which respectively transmit outgoing radio frequency signals to base station transceivers and receive incoming radio frequency signals from the base station transceivers via an antenna 216. The radio frequency signals transmitted between the mobile terminal 200 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The mobile terminal 200 may further include a wireless local area network (WLAN) interface transceiver 235 configured to establish a wireless data connection with another device, such as the POS terminal 102 of FIG. 1. The WLAN transceiver 235 may be configured to establish the wireless data connection according to a localized wireless connection protocol, such as a Bluetooth, Wi-Fi, and/or IR connection protocol. The mobile terminal 200 may also include an NFC module 227 for providing short-range communication functionality with other NFC equipped devices and systems, such as the POS terminal 102 of FIG. 1. The NFC module 227 may communicate with other NFC equipped devices using, for example, magnetic field induction over the 13.56 MHz frequency band. NFC may have a maximum communication range of about 10 centimeters (cm).

The processor 240 communicates with the memory 235 via an address/data bus. The processor 240 may be, for example, a commercially available or custom microprocessor. The memory 235 is representative of the one or more memory devices containing the software and data used to operate the mobile terminal as well as to perform a transaction in which the user of the mobile terminal is authenticated as the purchaser. The memory 235 may include, but is not limited to, the following types of devices: cache, ROM, PROM, EPROM, EEPROM, flash, SRAM, and DRAM.

The foregoing components of the mobile terminal 200 may be included in many conventional mobile terminals and their functionality is generally known to those skilled in the art.

As shown in FIG. 2, the memory 235 may contain multiple categories of software and/or data, including: an operating system 265, a cellular communication module 270, an NFC communication module 275, a transaction module 285, and a credit account database 290. The operating system 265 generally controls the operation of the mobile terminal 200. In particular, the operating system 265 may manage the mobile terminal's software and/or hardware resources and may coordinate execution of programs by the processor 240. The cellular communication module 270 may be configured to manage the cellular communication protocols that are used to allow the mobile terminal 200 to communicate with other devices and systems. The NFC module 275 may be configured to manage the NFC protocols that are used to allow the mobile terminal 200 to communicate with other NFC equipped devices and systems. The credit account database 290 may include user account information for one or more credit sources, such as the credit sources 150-1 through 150-n of FIG. 1, with whom the user of the mobile terminal 200 has an active account. The transaction module 285 may be configured to manage transactions with other devices by providing account information from the credit account database 290 and/or authentication/validation for the user of the mobile terminal 200.

As further described herein, when a user of the mobile terminal 200 initiates a purchase transaction according to some embodiments, a communication link is established between the mobile terminal 200 and the POS terminal via the NFC module 227. The POS communicates the price, product, and/or bar code information associated with the purchased item(s), and the transaction module 285 of the mobile terminal 200 transmits a notification of the transaction (as well as other desired transaction details) to one or more credit sources, such as the credit sources 150-1 through 150-n of FIG. 1, via the transceiver 230 either directly or through one or more intermediate points. For example, the notification may be provided to the credit sources via a credit information aggregator service, such as the credit aggregator device 120 of FIG. 1, which may be an external server in some embodiments, but may be part of the transaction module 285 of the mobile terminal 200 in other embodiments. Based on the received transaction notification, one or more of the credit sources may transmit transaction-specific offer information to the mobile terminal 200. As such, the mobile terminal 200 may receive and present the transaction-specific offers to the user via the display 210 at the point-of-sale. Each of the transaction-specific offers may be associated with one of the user's credit card accounts and/or other credit source. The mobile terminal 200 may then receive a user selection of one of the available credit sources based on the most attractive offer via the user interface 255, and the transaction module 285 may access the credit account database 290 and transmit the account information for the selected credit source to the POS terminal via the NFC module 227 to complete the purchase transaction.

Although FIG. 2 illustrates an exemplary software and hardware architecture that may be used to receive transaction-specific offers from multiple credit sources at the point-of-sale in accordance with some embodiments, it will be understood that the present invention is not limited to such a configuration, but is intended to encompass any configuration capable of carrying out the operations described herein.

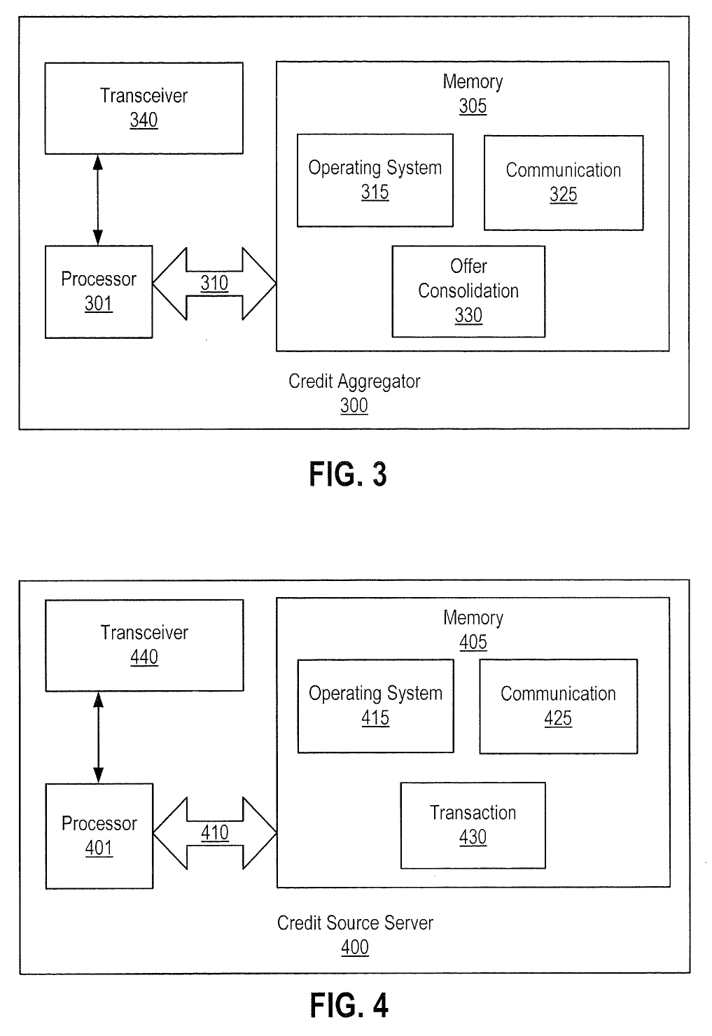

FIG. 3 illustrates a software architecture of a credit aggregator 300 in accordance with some embodiments. In some embodiments, the credit aggregator 300 may correspond to the credit aggregator device 120 of FIG. 1. Referring now to FIG. 3, the credit aggregator 300 includes a processor 301, a transceiver 340, and a memory 305. The processor 301 communicates with the memory 305 via an address/data bus 310. The processor 301 may be, for example, a commercially available or custom microprocessor. The memory 305 is representative of the one or more memory devices containing the software and data used to facilitate a point-of-sale transaction in accordance with embodiments. The memory 305 may include, but is not limited to, the following types of devices: cache, ROM, PROM, EPROM, EEPROM, flash, SRAM, and DRAM. The transceiver 340 includes a transmitter circuit and a receiver circuit, which are used to establish and maintain communication with another party or destination via a network, such as the network 140 of FIG. 1.

As shown in FIG. 3, the memory 305 may contain multiple categories of software and/or data: an operating system 315, a communication module 325, and an offer consolidation module 330. The operating system 315 generally controls the operation of the credit aggregator 300. In particular, the operating system 315 may manage the credit aggregator's software and/or hardware resources and may coordinate execution of programs by the processor 301. The communication module 325 may be configured to manage the communication protocols, including both wireless and wireline protocols, that are used by the transceiver 340 to communicate with other devices and systems, such as the mobile terminal 110 and/or the credit sources 150-1 through 150-n, over the communication network 140 of FIG. 1. The offer consolidation module 330 is configured to manage and/or consolidate the various transaction-specific offers received from the credit sources.

In particular, the offer consolidation module 330 may receive a notification of a currently pending transaction from a consumer electronic device (such as the mobile terminal 110 of FIG. 1) at the point-of-sale, and may transmit details of the transaction to one or more credit sources (such as the credit sources 150-1 through 150-n) via the transceiver 340. The transaction details may include a total purchase amount, an identity of the items purchased including the price per item, the identity of the consumer, and/or the identity of the vendor of the items. In some embodiments, the credit sources may specify particular transaction details that they desire to receive, and the offer consolidation module 330 of the credit aggregator 300 may forward only the requested transaction details to those credit sources. In response to transmitting the transaction details, the credit aggregator 300 may receive transaction-specific offers from one or more of the credit sources via the transceiver 340. In some embodiments, after receiving the offers, the offer consolidation module 330 may transmit the competing offers received from other credit sources to each of the offering credit sources via the transceiver 340, and, in response, may receive a new or revised transaction-specific counteroffer from one or more of the offering credit sources that is more competitive with the competing offers.

The offer consolidation module 330 may thereby consolidate the multiple transaction-specific offers received from the credit sources, for example, to provide a list of offers and the credit sources associated with the offers. In some embodiments, the offer consolidation module 330 may organize the received transaction-specific offers from multiple credit sources into a tabular format that lists the credit source and the particular terms of each offer, for ease of comparison. As such, the offer consolidation module 330 may, via the transceiver 340, transmit the consolidated transaction-specific offers to the consumer device at the point-of-sale for presentation to the consumer. The consumer may thereby select one of the available credit sources based on the presented transaction-specific offers to complete the transaction.

Although FIG. 3 illustrates an exemplary credit aggregator software architecture in accordance with some embodiments it will be understood that the present invention is not limited to such a configuration but is intended to encompass any configuration capable of carrying out the operations described herein. Also, it is to be understood that the software architecture and/or functionality of the credit aggregator 300 may be included in the mobile terminal 200 of FIG. 2 in some embodiments.

FIG. 4 illustrates a software architecture of a credit source server 400 in accordance with some embodiments. In some embodiments, the credit source server 400 may correspond to one of the credit sources 150-1 through 150-n of FIG. 1. Referring now to FIG. 4, the credit source server 400-includes a processor 401, a transceiver 440, and a memory 405. The processor 401 communicates with the memory 405 via an address/data bus 410. The processor 401 may be, for example, a commercially available or custom microprocessor. The memory 405 is representative of the one or more memory devices containing the software and data used to facilitate a point-of-sale transaction in accordance with some embodiments. The memory 405 may include, but is not limited to, the following types of devices: cache, ROM, PROM, EPROM, EEPROM, flash, SRAM, and DRAM. The transceiver 440 includes a transmitter circuit and a receiver circuit, which are used to establish and maintain communication with another party or destination.

As shown in FIG. 4, the memory 405 may contain multiple categories of software and/or data: an operating system 415, a communication module 425, and a transaction module 430. The operating system 415 generally controls the operation of the credit server 400. In particular, the operating system 415 may manage the credit server's software and/or hardware resources and may coordinate execution of programs by the processor 401. The communication module 425 may be configured to manage the communication protocols, including both wireless and wireline protocols, that are used by the transceiver 440 to communicate with other devices and systems, such as the credit aggregator device 120 and/or the mobile terminal 100 of FIG. 1, via the communication network 140. The transaction module 430 may be configured to manage and complete transactions with other devices, such as the POS terminal 102 of FIG. 1, in response to receiving valid consumer account information therefrom.

The transaction module 430 may also be configured to present transaction-specific offers from the credit source to a consumer at the point-of-sale. In particular, in response to receiving a notification of a currently pending transaction from a consumer electronic device at the point-of-sale (such as the mobile terminal 110 of FIG. 1) and/or from an intermediary credit information aggregation service (such as the credit aggregator device 120 of FIG. 1), the transaction module 430 may transmit a transaction-specific offer back to the consumer device via the transceiver 440. The transaction-specific offer may be, for example, a purchase-specific interest rate, reward, and/or contractual credit term offered in exchange for completing the transaction using the credit source associated with the credit server 400. The transaction-specific-offer may also depend on the amount of the purchase, an identification of specific items being purchased, and/or based on the identity of the seller/vendor of such items. The transaction module 430 may be further configured to analyze the details of offers from other competing credit sources received from a consumer device and/or credit aggregator device via the transceiver 440, and transmit a new, more competitive transaction-specific offer to the consumer device based on the offers from the competing credit sources. The transceiver 440 may be configured to transmit the transaction-specific offer to the consumer device either directly or via an intermediary credit aggregation service in some embodiments.

Although FIG. 4 illustrates an exemplary credit source server software architecture in accordance with some embodiments, it will be understood that the present invention is not limited to such a configuration but is intended to encompass any configuration capable of carrying out operations described herein.

Computer program code for carrying out operations of devices, terminals, and/or systems discussed above with respect to FIGS. 1-4 may be written in a high-level programming language, such as Java, C, and/or C++, for development convenience. In addition, computer program code for carrying out operations of embodiments may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Exemplary embodiments are described herein with reference to message flow, flowchart and/or block diagram illustrations of methods, devices, and/or computer program products. These message flow, flowchart and/or block diagrams further illustrate exemplary operations for performing a transaction in which an electronic device, such as a mobile terminal, credit aggregator, and/or credit source server, presents transaction-specific offers to a consumer at the point-of-sale in accordance with various embodiments. It will be understood that each message/block of the message flow, flowchart and/or block diagram illustrations, and combinations of messages/blocks in the message flow, flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the message flow, flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the message flow, flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow, flowchart and/or block diagram block or blocks.

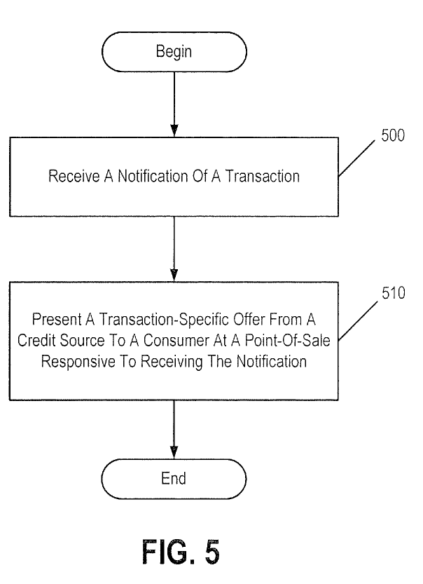

FIG. 5 is a flowchart illustrating operations for presenting transaction-specific offers to a consumer at the point-of sale in accordance with some embodiments. The operations of FIG. 5 may be performed by the mobile terminal 110, the credit aggregator device 120, and/or one or more of the credit servers 150-1 through 150-n of FIG. 1. Operations begin at block 500 where a notification of a current transaction is received. The notification may be received from a device associated with the point-of sale, such as a point-of-sale terminal and/or a consumer electronic device. At block 510, responsive to receiving the notification, a transaction-specific offer is presented to a consumer at the point-of-sale. More particularly, at least one available credit source with whom the consumer has an active account may communicate the transaction-specific offer to a consumer electronic device and/or intermediary credit aggregator device, which may present the transaction specific offer to the consumer. The transaction may then be completed using a credit source associated with the transaction-specific offer, for example, in response to receiving a consumer selection of one of the available credit sources. Where offers from multiple credit sources are received, the consumer may select the credit source based on the most attractive offer presented by the available credit sources.

For example, a mobile terminal or other consumer electronic device may receive the notification at block 500 from a point-of-sale terminal, and may present the transaction-specific offer to the consumer at the point-of-sale at block 510 via the display of the mobile terminal. Responsive to receiving a consumer selection of a credit source, the mobile terminal may complete the transaction by transmitting account information for the selected credit source to the point-of-sale terminal.

Additionally or alternatively, a credit source server may receive the notification at block 500 from the mobile terminal or other consumer electronic device, either directly or indirectly via an intermediary credit aggregator device. The credit source server may present the transaction-specific offer from the credit source to the consumer at the point-of-sale at block 510 by transmitting the transaction-specific offer to the consumer's mobile terminal directly, or indirectly via the intermediary credit aggregator device. The credit source server may complete the transaction responsive to receiving account information for the consumer from the point-of-sale terminal.

As a further alternative, a credit aggregator device may receive the notification from the mobile terminal or other consumer electronic device at block 500. The credit aggregator device may forward the notification and/or specific details of the transaction to at least one available credit sources for the consumer, and may receive at least one transaction-specific offer therefrom in response to the notification. Responsive to receiving at least one transaction-specific offer from a credit source, the credit aggregator device may present the transaction-specific offer from the credit source to the consumer at block 510 by transmitting the transaction-specific offer to the consumer's mobile terminal.

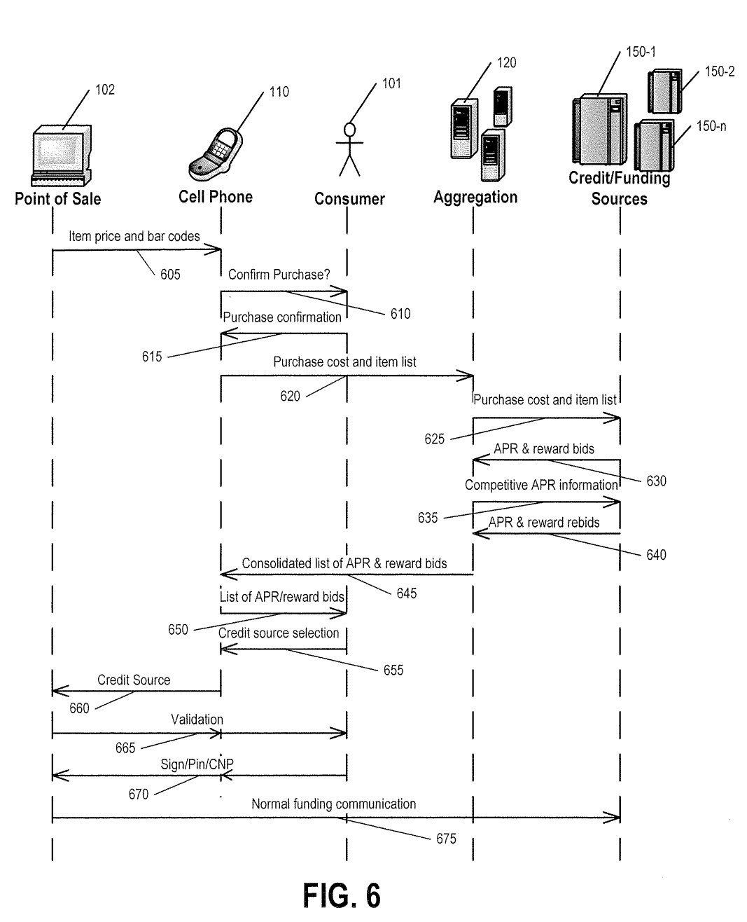

FIG. 6 is a flow diagram illustrating more detailed operations for providing transaction-specific offers from a plurality of credit sources to an electronic device at a point-of-sale in accordance with some embodiments. Referring now to FIG. 6, upon initiation of a transaction, items are tallied on a point-of-sale (POS) terminal 102. The POS terminal 102 communicates a notification to the consumer's mobile terminal 110, including, for example, the total transaction price and/or scanned barcodes for the item(s) to be purchased in the transaction (step 605). In accordance with various embodiments, the notification may be communicated to the mobile terminal 110 via NFC. The mobile terminal 110 displays a notice to the consumer 101 requesting confirmation of the transaction (step 610), and receives a purchase confirmation from the consumer 101 via a user interface (step 615).

The mobile terminal 110 communicates with a credit aggregator device 120 to notify the credit aggregator device 120 of the pending transaction, as well as, for example, the total purchase amount and the list of items being purchased (step 620). In accordance with various embodiments, the mobile terminal 110 may communicate with the credit aggregator device 120 via a cellular communication link. For additional security, the transaction information may be encrypted. The credit aggregator device 120 communicates the details of the pending transaction, including the total purchase amount and/or the list of items, to one or more available credit sources 150-1 through 150-n (step 625), and at least some of the credit sources 150-1 through 150-n communicate transaction-specific offers back to the credit aggregator device 120 (step 630). The transaction-specific offers may include a particular interest rate, reward, and/or contractual terms offered to the consumer in exchange for using the corresponding credit source to complete the pending transaction. The credit sources 150-1 through 150-n may also communicate information regarding the consumer's credit balances and/or current credit limits to the credit aggregator device 120.

Upon receiving transaction specific offers from one or more of the credit sources 150-1 through 150-n, the credit aggregator device 120 may return competing offer information from other credit sources back to each of the offering credit sources 150-1 through 150-n (step 635). One or more of the credit sources 150-1 through 150-n may thereby communicate a more competitive transaction-specific counteroffer to the credit aggregator device 120 in response to the competing offers (step 640). The credit aggregator device 120 consolidates the outstanding offers from the credit sources 150-1 through 150-n, and communicates a consolidated list of the outstanding transaction-specific offers, as well as the credit balance and/or credit limit information received from the credit sources 150-1 through 150-n, to the consumer's mobile terminal 110 (step 645). The mobile terminal 110 thereby presents a list of the transaction-specific offers for the pending transaction and the associated credit sources to the consumer 101 via its display (step 650). The mobile terminal 110 may also present the credit balance and/or credit limit information from each credit source.

In response to the presented offers, the mobile terminal 110 receives a consumer selection of one of the credit sources 150-1 through 150-n via the user interface (step 655). The consumer's selection of a particular credit source may be based on the attractiveness of the offer presented by that particular credit source in comparison to the offers presented by the other credit sources. In response to receiving the consumer selection, the mobile terminal 110 transmits account information associated with the selected credit source to the POS terminal 102 (step 660). The POS terminal 102 transmits a validation request back to the mobile terminal 110, which is presented to the consumer 101 (step 665). The consumer enters her signature or personal identification number (PIN) in response to the validation request, and the mobile terminal 110 transmits the signature/PIN to the POS terminal 102 (step 670) as authorization to complete the transaction using the account associated with the selected credit source. Thus, the consumer is authenticated as being the person associated with the selected credit account. In response to receiving a valid authorization, the POS terminal 102 contacts the selected one of the credit sources 150-1 through 150-n using the account information and authentication provided by the mobile terminal 110 (step 675) to complete the transaction.

The flowchart and flow diagram of FIGS. 5-6 illustrate the architecture, functionality, and operations of embodiments of the mobile terminal 110, credit aggregator device 120, and/or credit source 150-1 through 150-n software. In this regard, each block or step represents a module, segment, or portion of code, which comprises one or more executable instructions for implementing the specified logical function(s). It should also be noted that in other implementations, the function(s) noted in the blocks or steps may occur out of the order noted in FIGS. 5-6. For example, two blocks/steps shown in succession may, in fact, be executed substantially concurrently or the blocks/steps may sometimes be executed in the reverse order, depending on the functionality involved.

Thus, according to some embodiments, credit card companies and/or other credit sources may present a specific offer to a consumer for a current transaction at the point-of sale. As such, rather than selecting a payment source based on static criteria, a consumer may be presented with dynamic offers, which may vary based on the cost, items, and/or vendor associated with the transaction, to entice the consumer to use a particular credit source at the time of a purchase.

Exemplary embodiments described herein may provide benefits to consumers, credit sources, and/or network service providers. For example, for credit sources, the ability to market their financial products to consumers at a time when such marketing would be most effective in influencing the consumer's actions may be vastly improved. For a network service provider, the service provider's wireless 3G and/or TCP/IP networks may be utilized for purchasing transactions, which may provide additional revenue. Providing network security along these networks would prioritized, and the strength and security of the service provider's network may be marketed to consumers. Commercial value may flow not only from data connection charges from the 3G network, but also from partnership arrangements with the credit sources. Finally, from a consumer perspective, the credit sources may compete to provide attractive credit options for the consumer at the time of purchase, thereby providing the consumer with the best possible credit terms for completing a transaction.

In the drawings and specification, there have been disclosed exemplary embodiments, and although specific terms are used, they are used in a generic and descriptive sense only and not for purposes of limitation, the scope of the invention being defined by the following claims.

That which is claimed:

1. A method of operating an electronic device to conduct a transaction, the method comprising:
receiving a notification of the transaction at the electronic device;
presenting, via the electronic device, a transaction-specific offer from a credit source to a user at the point-of-sale responsive to receiving the notification at the electronic device.

2. The method of claim 1, further comprising:
transmitting details of the transaction either directly or indirectly to the credit source responsive to receiving the notification;
receiving the transaction-specific offer either directly or indirectly from the credit source responsive to transmitting the details of the transaction thereto.

3. The method of claim 2, wherein transmitting and receiving further comprises:
transmitting the details of the transaction to a plurality of available credit sources for the user responsive to receiving the notification; and
receiving a plurality of transaction-specific offers from at least some of the plurality of available credit sources responsive to transmitting the details of the transaction thereto,
wherein presenting the transaction-specific offer comprises presenting the plurality of transaction-specific offers to the user responsive to receipt thereof.

4. The method of claim 3, further comprising:
transmitting competing ones of the plurality of transaction-specific offers to one of the plurality of available credit sources; and
receiving a revised transaction-specific offer from the one of the plurality of available credit sources responsive to transmitting the competing ones of the plurality of transaction-specific offers thereto,
wherein presenting the plurality of transaction-specific offers comprises presenting the revised transaction-specific offer to the user along with the competing ones of the plurality of transaction-specific offers.

5. The method of claim 3, wherein the electronic device comprises a credit aggregator device configured to communicate with the plurality of available credit sources, wherein receiving the notification comprises receiving the notification of the transaction from a mobile terminal associated with the user, and wherein presenting the transaction-specific offer comprises transmitting the plurality of transaction-specific offers to the mobile terminal responsive to receiving the plurality of transaction-specific offers from the respective ones of the plurality of available credit sources.

6. The method of claim 3, wherein the electronic device comprises a mobile terminal including account information for the plurality of available credit sources, wherein receiving the notification comprises receiving the notification of the transaction from a point-of sale terminal, wherein presenting the plurality of transaction specific-offers comprises displaying the plurality of transaction-specific offers on a display of the mobile terminal; and further comprising:
receiving a user selection of one of the plurality of available credit sources responsive to displaying the plurality of transaction-specific offers; and
completing the transaction by transmitting account information associated with the one of the plurality of available credit sources to the point-of sale terminal responsive to receiving the user selection thereof.

7. The method of claim 1, wherein the electronic device comprises a credit server associated with the credit source, wherein receiving the notification comprises receiving the notification of the transaction from one of a mobile terminal associated with the user and a credit aggregator device configured to communicate with the mobile terminal, wherein presenting the transaction-specific offer comprises transmitting the transaction-specific offer to the one of the mobile terminal and the credit aggregator device responsive to receiving the notification of the transaction therefrom, and further comprising:
completing the transaction with a point-of-sale terminal responsive to receiving account information for the user from the point-of-sale terminal.

8. The method of claim 1, further comprising:
receiving at least one competing offer for the transaction associated with another credit source; and
presenting a revised transaction-specific offer to the user in response to receiving the at least one competing offer.

9. The method of claim 1, wherein the notification indicates at least one of a purchase amount, a vendor associated with the transaction, and an identification of items to be purchased in the transaction.

10. The method of claim 1, wherein the transaction-specific offer comprises an offer for at least one of an annual percentage rate, a reward, and a contractual term as consideration for completion of the transaction using the credit source.

11. The method of claim 1, wherein the credit source comprises a server associated with a credit card company, a bank, and/or other financial institution with whom the user has an active account.

12. An electronic device for conducting a transaction, comprising:
a receiver configured to receive a notification of the transaction; and
a processor coupled to the receiver and configured to present a transaction-specific offer from a credit source to a user at a point-of-sale responsive to receipt of the notification.

13. The electronic device of claim 12, further comprising:
a transmitter coupled to the processor and configured to transmit transaction details of the transaction either directly or indirectly to the credit source responsive to receipt of the notification,
wherein the receiver is configured to receive the transaction-specific offer either directly or indirectly from the credit source responsive to transmission of the details of the transaction thereto.

14. The electronic device of claim 13, wherein the transmitter is further configured to transmit the details of the transaction to a plurality of available credit sources for the user, wherein the receiver is further configured to receive a plurality of transaction-specific offers from at least some of the plurality of available credit sources responsive to transmission of the details of the transaction thereto, and wherein the processor is further configured to present the plurality of transaction-specific offers to the user responsive to receipt thereof.

15. The electronic device of claim 14, wherein the transmitter is configured to transmit competing ones of the plurality of transaction-specific offers to one of the plurality of available credit sources, wherein the receiver is configured to receive a revised transaction-specific offer from the one of the plurality of available credit sources responsive to transmitting the competing ones of the plurality of transaction-specific offers thereto, and wherein the processor is configured to present the revised transaction-specific offer to the user along with the competing ones of the plurality of transaction-specific offers.

16. The electronic device of claim 14, wherein the electronic device comprises a credit aggregator device configured to communicate with the plurality of available credit sources, wherein the receiver is configured to receive the notification of the transaction from a mobile terminal associated with the user, and wherein the processor is configured to present the plurality of transaction-specific offers by transmitting the plurality of transaction-specific offers to the mobile terminal via the transmitter responsive to receipt of the plurality of transaction-specific offers from the respective ones of the plurality of available credit sources.

17. The electronic device of claim 14, wherein the electronic device comprises a mobile terminal including account information for the plurality of available credit sources, wherein the receiver is configured to receive the notification of the transaction from a point-of-sale terminal, the electronic device further comprising:
a display coupled to the processor and configured to present the plurality of transaction-specific offers by displaying the transaction-specific offers thereon; and
a user interface configured to receive a user selection of one of the plurality of available credit sources responsive to display of the plurality of transaction-specific offers via the display,
wherein the processor is configured to complete the transaction by transmitting account information associated with the one of the plurality of available credit sources to the point-of sale terminal via the transmitter responsive to receipt of the user selection thereof via the user interface.

18. The electronic device of claim 12, wherein the electronic device comprises a credit server associated with the credit source, wherein the receiver is configured to receive the notification of the transaction from one of a mobile terminal associated with the user and a credit aggregator device configured to communicate with the mobile terminal, the electronic device further comprising:
a transmitter coupled to the processor and configured to present the transaction-specific offer by transmitting the transaction-specific offer to the one of the mobile terminal and the credit aggregator device responsive to receipt of the notification of the transaction therefrom,
wherein the processor is configured to complete the transaction with a point-of-sale terminal responsive to receiving account information for the user therefrom via the receiver.

19. The electronic device of claim 12, wherein the receiver is further configured to receive at least one competing offer for the transaction associated with another credit source, and wherein the processor is configured to present a revised transaction-specific offer to the user responsive to receipt of the at least one competing offer.

20. A computer program product for operating an electronic device to conduct a transaction, the computer program product comprising a computer readable storage medium including computer readable program code embodied therein, the computer readable program code comprising:
computer readable program code configured to receive a notification of the transaction;
computer readable program code configured to present a transaction-specific offer from a credit source to a user at a point-of-sale responsive to receiving the notification.
